(19) United States
(12) Patent Application Publication
(10) Pub. No.: US 2004/0103058 A1
(43) Pub. Date: May 27, 2004

(54) Decision analysis system and method

(76) Inventor: Ken Hamilton, Dallas, TX (US)

Correspondence Address: HOWISON & ARNOTT, L.L.P, P.O. BOX 741715, DALLAS, TX, 75374-1715, US

(21) Appl. No.: 10/651,387

(22) Filed: Aug. 29, 2003

Related U.S. Application Data
(60) Provisional application No. 60/409,728, filed on Sep. 11, 2002.
(60) Provisional application No. 60/407,550, filed on Aug. 30, 2002.

(51) Int. Cl. G06F 17/60

(52) U.S. Cl. 705/38

(57) ABSTRACT

A decision analysis system includes a decision group and a model base communicably connected to the decision group. The model base includes models representing multi-criteria decision analysis and Bayesian analysis techniques. Upon receiving a decision task, the decision group organizes the decision analysis process for the decision task by identifying decision analysis components. The decision group selects one or more appropriate models from the model base for each decision analysis component.

### CROSS-REFERENCE TO RELATED APPLICATIONS

This application claims priority on U.S. Provisional Patent Application Serial No. 60/409,728 (HAMK-26,177) entitled “System and Method for Security Management Decision Analysis,” filed Sep. 11, 2002 and U.S. Provisional Patent Application Serial No. 60/407,550 (HAMK-26,170) entitled “System and Method for Service Management Decision Analysis,” filed Aug. 30, 2002.

### TECHNICAL FIELD OF THE INVENTION

The invention relates in general to the field of expert systems and more particularly to analysis and decision management.

### BACKGROUND OF THE INVENTION

In a world flooded with information, where decisions become complex in sifting, sorting and identifying relevance, the keys to decision making depend largely on coordinated management of the analysis and decision making processes. In many cases, the information necessary to make an informed decision is readily accessible, but without an integrated approach to analysis and decision making, it can be difficult to properly use the information at hand.

Decision analysis is relevant to virtually every field of human endeavor. Resource management, service management, government, commercial industry, asset management, security management and a host of other fields require decision analysis. One field in which the need for appropriate analysis and decision tools is readily apparent is security. Security for people, assets and information is key to all aspects of life today. Logical and physical security systems and their supporting processes and networks are important business and social assets. Protecting the confidentiality, integrity and availability of information and assets may be essential for business, governments and other organizations to maintain a competitive edge, cash-flow, profitability, legal compliance, commercial image, responsibility, reliability, responsiveness, accountability, resource security, personnel security, national security, safety and other organizational concerns.

Increasingly, organizations and their information systems and networks are faced with security threats from a wide range of sources, including computer-assisted fraud, espionage, sabotage, vandalism, fire or flood. Sources of damage such as computer viruses, computer hacking and denial of service attacks have become more common, more ambitious and increasingly sophisticated. Governments must provide homeland security, information security and military security. The complexities of these undertakings can be staggering.

Increased and ubiquitous dependence on information systems and services, in particular, means organizations are more vulnerable to security threats. The interconnecting of public and private networks and sharing of information resources increases the difficulty of maintaining access control. The trend to distributed computing has weakened the effectiveness of centralized system controls. Many information systems simply were not designed to be secure. A rash of security solutions, particularly technical security solutions, have arisen.

The security that can be achieved through purely technical means is limited, and is only really effective when properly implemented and constantly supported by appropriate management and procedures. Identifying which controls should be in place requires careful planning and attention to detail. Information security management needs participation by most, if not all, employees in the organization. It may also require participation from suppliers, customers or shareholders. Specialist advice from outside organizations may also be needed. Security management, including analysis and decision protocols, is essential to any robust security system.

A variety of security policies exist that apply to both civil and defense agencies. For the most part, these security policies do not reflect an interdependent, cohesive collection of security disciplines, but exist as though they operated independently of any other policy. This proliferation of disjointed policy makes it difficult for security personnel to keep up with changes, much less keep aware of all the applicable policies for a given system. Rapidly changing technology also makes it difficult for policy to keep up with new security challenges caused by advances in capabilities and technology.

Current security systems and methods exhibit several problems. These problems include a lack of process integration, a lack of tool interoperability and a lack of cross domain integration. The current systems tend to overemphasize technical countermeasures. They tend to underestimate the operational requirements necessary to implement recommended solutions. Current system tend to ignore or undervalue qualitative data and otherwise don't take qualitative or uncertain data into account. They usually lack a life-cycle model for security. They typically don't integrate with service management methods. The analytical models used in current security system are typically limited to risk metrics.

The key challenge for the information security manager is to locate and utilize a methodology where the limited quantitative data that is available may be combined with the more qualitative “expert” opinion in a formalized and repeatable process.

A way of providing balance for management in the tradeoffs of comfort, cost, and feasibility is needed. There are a number of methods in this arena such as cost benefit analysis, decision trees, and decision matrices. Multi-criteria decision analysis provides a flexible method of managing decisions that include a variety of criteria. Analytical Network Process is an example of a multi-criteria decision analysis process that provides greater depth of analysis than many other methods and can be utilized more effectively with both quantitative and qualitative data. These methods may be combined with analysis based on Bayesian networks. The use of Bayesian techniques to augment analysis allows the user to quantify uncertain criteria. It is becoming especially important in an age when an organization must offer proof of “due diligence” in the analysis and management of security tradeoffs and prevention.

To forestall attacks, security systems and methods need to be scaled appropriately, typically small-scale, redundant, and compartmentalized. Rather than large, sweeping programs, they should be carefully crafted mosaics, each piece should be adaptable to deal with specific weakness. To halt attacks once they start, security measures must avoid being subject to single points of failure. Computer networks are particularly vulnerable: once hackers bypass the firewall, the whole system is often open for exploitation. Because every security measure in every system can be broken or gotten around, failure must be incorporated into the design. No single failure should compromise the normal functioning of the entire system or, worse, add to the gravity of the initial breach. Finally, and most important, decisions need to be made by people at close range-and the responsibility needs to be given explicitly to people aided in their analysis and decisions by computers, rather than computers deciding with minimal human input.

### SUMMARY OF THE INVENTION

A decision analysis system includes a decision group and a model base communicably connected to the decision group. The model base includes models representing multi-criteria decision analysis and Bayesian analysis techniques. Upon receiving a decision task, the decision group organizes the decision analysis process for the decision task by identifying decision analysis components. The decision group selects one or more appropriate models from the model base for each decision analysis component.

### DESCRIPTION OF THE DRAWINGS

For a more complete understanding of the present invention and the advantages thereof, reference is now made to the following description taken in conjunction with the accompanying Drawings in which:

FIG. 1 illustrates decision analysis system;

FIG. 2 illustrates a flowchart of a decision analysis process;

FIG. 3 illustrates a decision frame for an IT security network;

FIG. 4 illustrates an IT security process overview

FIG. 5 illustrates a peer-to-peer collaboration flow;

FIG. 6 illustrates a multi-criteria ANP/Bayesian network; and

FIG. 7 illustrates a graphical representation of a process maturity model.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

Using a cellular approach to the security life-cycle, the preferred embodiment uses an applied multi-criteria Bayesian group decision and analysis process. This allows a cross-organizational forward and feedback multi-criteria decision analysis mechanism with life-cycle support from an object oriented service management model.

Security decisions regarding the life-cycle, including scoping, assessment, through operations and retirement can be managed by the present system. Existing systems do not address this in a structured way. For instance the need to have security processes and systems kept up to date and for documentation and training to be coordinated with changes to the processes and systems relationships is ultimately key to success of the security program. Using service management discipline adapted from a security perspective facilitates the “operational” aspects of security. Incident, problem, change and configuration other service management processes are key to the effectiveness and efficiency of the security life cycle.

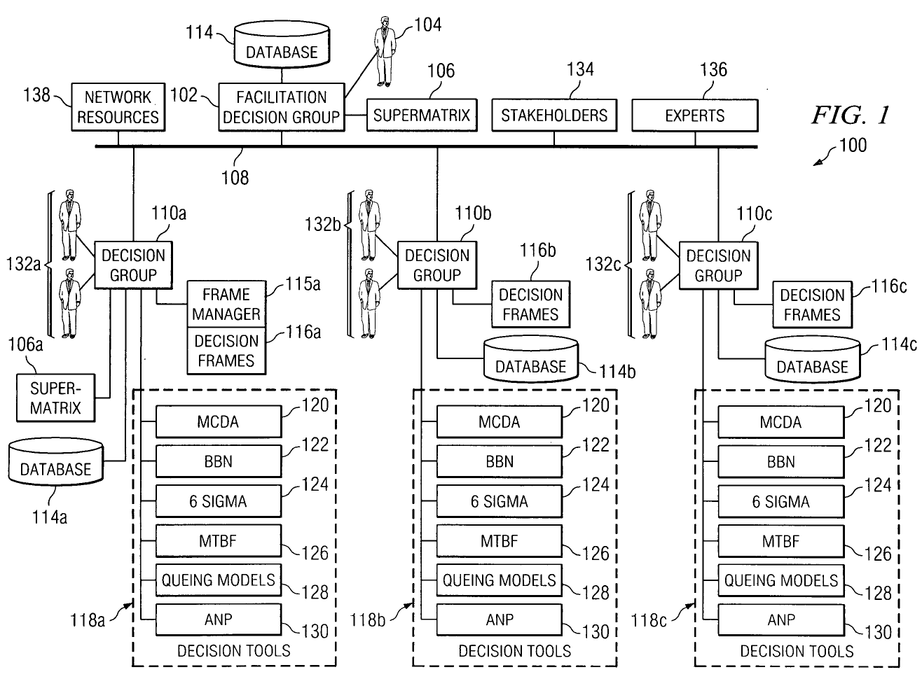

With reference to FIG. 1, a group decision management system 100 is shown. The group decision management system 100, in accordance with the preferred embodiment, includes a facilitator decision group server 102 connected in a peer-to-peer fashion using a network 108 to one or more decision group servers 110a, 110b and 110c. A facilitator is a role performed by one or more users or decision groups in the decision analysis process, such that any user or decision group may act as the facilitator in a given decision analysis process. In some cases, the functions of the facilitator decision group server 102 and the decision group servers 110 could be performed by a single computer. The functions of the facilitator server 102 and a decision group server 110 could be performed by a single computer, connected by a network 108 to other decision group servers 110. The functions of two or more decision group servers 110 could be performed by a single computer connected by a network 108 to a facilitator server 102 and one or more other decision group servers 110. Conversely, multiple machines communicably connected together may perform the functions of a group server 110. The groupings are logical rather than physical.

The facilitator group decision server 102 receives commands from a facilitator 104. For example, the facilitator decision group server may create a super-matrix 106 when analytical network processing is implemented.

A super-matrix 106 describing the interaction between the components of the system is constructed from priority vectors. The super-matrix 106 can be used to assess the results of feedback. Each of the columns of a super-matrix 106 is an eigenvector that represents the impact of all the elements in the component on each of the elements in the component. Interaction in the super-matrix 106 is measured according to several possible criteria whose priorities and relations are represented in a control hierarchy and/or network. The components are compared according to their relative impact on each other component, thus developing priorities to weight the eigenvector columns in the super-matrix 106.

A decision group server 110 may create and access its own super-matrix 106a, although in a given decision analysis, the facilitators super-matrix will typically control the processes. The decision group server 110 may access one or more databases 114a or other information sources. The decision group server may be provided with decision frames 116 as well as other decision tools 118. The decision tools 118 may include multi-criteria decision analysis (MCDA) 120, including analytical network processing (ANP) 130, bayesian belief networks (BBN) 122, 6 sigma 124, mean time between failures (MTBF) 126, queuing models 128, and any other analytical tool. The specific tools are chosen as appropriate to the specific question given. For example, 6 sigma 124 and MTBF 126 are most appropriate to discrete questions and so could be applied where specific discrete questions are raised.

The network 108 also provides access to a variety of network resources 138, including public databases, Internet resources and other groups. Stakeholders 134 and experts 136 may also be available for input to the various decision making processes via the network 108.

Each decision group server 110 is assigned tasks by the facilitator 102, generally corresponding with the expertise of the decision group server 110. The tasks assigned by the facilitator 102 include providing analysis and decisions regarding elements that are in turn used to make the final decision. For example, a decision group server 110 associated with a team of financial experts 132 and financial data 114 will typically be assigned to making necessary financial determinations. These financial determinations, which may be simply data or data analysis, or may itself consist of the results of multi-criteria decision making processes and bayesian analysis. Requests for analysis and decision may also come from other decision groups in the course of providing their own analysis and decisions.

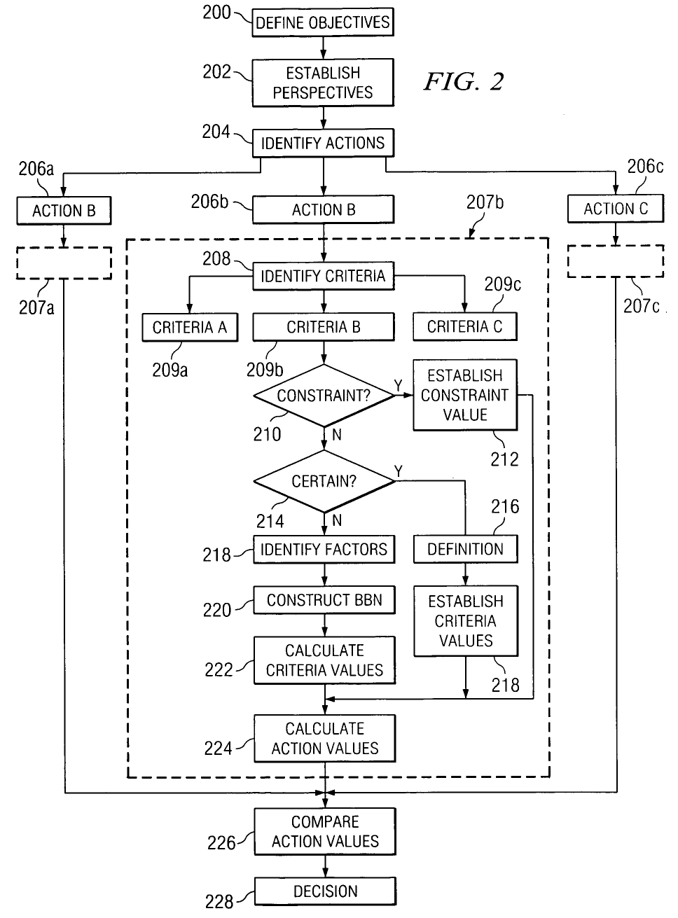

With reference to FIG. 2, a flowchart of the decision analysis process is shown. In function block 200, a decision or other type of objective is formed by the facilitator with reference to the decision groups, experts, stakeholders and decision makers. The perspectives which the decision must be considered is established in function block 202. Actions that may be taken are identified in function block 204. Any number of actions 206a, 206b and 206c, may be identified. For each possible action, decision analysis 207 is performed. For Action A in function block 206a, decision analysis 207a is performed. For Action B in function block 206b, decision analysis 207b is performed. For Action C in function block 206c is performed. Each action is typically assigned to a decision group where the decision analysis is performed.

The decision analysis 207 begins with identification of criteria related to the action in function block 208. Any number of criteria 209a, 209b, 209c, may be identified. Analysis is performed for each criteria. In the example of Criteria B 209b, the process continues to decision block 210 which determines if the criteria is constrained, such that it has a definite value or range of acceptable values. If the criteria is constrained, the process follows the YES path to function block 212 where the constraint values are established. This value is then used in function block 224 where the action value is calculated.

If the criteria is not constrained, the process follows the NO path to decision block 214 where it is determined if the criteria is certain or uncertain. If the criteria is certain, the process follows the YES path to function block 216 where the criteria is defined. Once defined, the process proceeds to function block 218 where the criteria values are established in accordance with the definition. These values are used in function block 224 to calculate the action values.

If the criteria is uncertain, the process follows the NO path to function block 218 where the factors for the criteria are identified. A Bayesian belief network is constructed in function block 220, using the factors identified in function block 218. Using the Bayesian belief network, the criteria values are established in function block 222. These criteria values are used to calculate the action values in function block 224.

Once the action values for each of the proposed actions are calculated, the action values are compared in function block 226. A decision recommendation is determined in function block 228. If the decision recommendation is unacceptable or otherwise incomplete, the process may repeat from function blocks 200, 204 or 208, depending on the determination of the facilitator 104.

The present method and system allows for a balance between operational security service levels, particularly the ability to meet organizational objectives, and cost/financial impact regarding capacity, availability and service continuity integrated into the decision and analysis process. Security and availability are inversely related and so the needs of an organization has with respect to security tend to reduce availability, while increasing availability makes security more difficult to maintain.

The decision analysis system 100 enables the ability to design, develop, implement, support and update a variety of system mechanisms. For example, the decision analysis system 100 may be used in service management, particularly security management. By incorporating each service management aspect into decision analysis in the context of business objectives and related system management support disciplines, the decision analysis system 100 continually integrates each of the appropriate perspectives into all relevant decisions.

The decision analysis system 100 facilitates group input and decision making. The decision analysis system 100 allows for distributed and/or asynchronous support through a peer-to-peer or client/server architectures. The decision analysis system 100 provides a consistent repeatable mechanism for multi-criteria decision analysis such as the analytical network process combined with Bayesian belief networks. The present system can provide analytical model linking levels of abstraction. The principles of the system apply to all types of life cycle analysis and decision making in a wide variety of organizational environments, including information technology, system design, construction, community management, event management, airline, restaurant, governmental, military.

The decision analysis system 100 for use in a security environment may address key security processes, guidelines, metrics, roles and responsibilities, costs, benefits, possible problems, relation to other functions, planning and control.

A decision analysis system 100 used for security purposes may use a variety of security metrics. The number of false positives and false negatives may be measured. The number of incidents reported may be measured. The number of security policy violations during a given period may be measured. The number of policy exceptions allowed may be measured. The percentage of expired passwords and the number of guessed passwords may be measured. The number of security incidents during a given period and the cost of monitoring during a period may be measured. Metrics are particularly useful as quantitative measures that may be used in various multi-criteria decision techniques.

Security analysis and management includes a factor of uncertainty, which will vary dependent upon the specifics of a particular situation. This means that the likelihood can only be predicted within certain limits. In addition, impact assessed for a particular risk also has associated uncertainty, as the unwanted incident may not turn out as expected. Thus the majority of factors have uncertainty as to the accuracy of the predictions associated with them. In many cases these uncertainties may be large. This makes planning and the justification of security very difficult.

Anything that can reduce the uncertainty associated with a particular situation is of considerable importance. For this reason, assurance is important as it indirectly reduces the risk of the system.

The risk information produced by this process area depends on threat information, vulnerability information, and impact information. While the activities involved with gathering threat, vulnerability, and impact information have been grouped into separate process areas, they are interdependent. The goal is to find combinations of threat, vulnerability, and impact that are deemed sufficiently risky to justify action.

This information forms the basis for the definition of security needs and the security inputs. Since risk environments are subject to change, they must be periodically monitored to ensure that the understanding of risk generated by this process area is maintained at all times.

A limited set of consistent metrics minimizes the difficulty in dealing with divergent metrics. Quantitative and qualitative measurements can be achieved in a number of ways, such as establishing the financial cost, assigning an empirical scale of severity, e.g., 1 through 10, and the use of adjectives selected from a predefined list, e.g., low, medium, high.

The decision analysis system 100 may identify, analyze, and prioritize operational, business, or mission directives. The influence of the business strategies may also be considered. These criteria will influence and moderate the impacts to which the organization may be subjected. This in turn is likely to influence the sequence in which risks are addressed in other base practices and process areas. It may be important to factor in these influences when the potential impacts are being examined. This base practice is related to the activities of a Specify Security Needs task.

The decision analysis system 100 may use system priority lists and impact modifiers as well as a system capability profile, which describes the capabilities of a system and their importance to the objective of the system.

Functional and information assets can be interpreted according to their value and criticality in the defined environment. Value can be the operational significance, classification, sensitivity level, or any other means of specifying the perceived value of the asset to the intended operation and use of the system. Criticality can be interpreted as the impact on the system operation, on human lives, on operational cost and other critical factors, when a leveraged function is compromised, modified, or unavailable in the operational environment. Assets may also be defined in relation to their applicable security requirements. For example, assets may be defined as the confidentiality of a client list, the availability of interoffice communication, or the integrity of payroll information. Many assets are intangible or implicit, as opposed to explicit. The risk assessment method selected should address how capabilities and assets are to be valued and prioritized.

Information security is achieved by implementing a suitable set of controls, which could be policies, practices, procedures, organizational structures and software functions. These controls need to be established to ensure that the specific security objectives of the organization are met. Information security controls are considerably cheaper and more effective if incorporated at the requirements specification and design stage. Success depends upon managing resources efficiently and effectively to provide security based upon overall requirements.

Like any complex issue needing resolution, security management needs to be broken down into more manageable components and enhanced. An architectural discipline is necessary to standardize the approach to instrumenting the process with measurement points and tying that to a common security management architecture. Managing security requires a set of core processes supported by group decision analysis across multiple business and technical domains.

Available best practice in service management includes the IT Infrastructure Library (ITIL) and the British Standards Institute standard BS 15000. Available best practice in IT Security has evolved with the publication of the first BS 7799, the British Standards Institute Security standard which has evolved into ISO 17799, the International security standard

Available best practice now comprises integrated guidance from the British Standards Institute (BSI), ISO as well as other derivatives. Other security standards and methods include the US NIST standards, SSE CMM and the Carnegie Mellon Software Engineering Institute (SEI) Octave method. Governmental security requirements range from Federal airline security regulations to HIPPA health care information privacy regulations. Additionally the IT security industry is supported by the Certified Information Systems Security Professional (CISSP) qualifications and training structure that has been adopted as recognition of professional competence in IT Security knowledge.

The decision analysis system 100 provides a re-configurable, adaptable and responsive security management improvement model, based on multiple criteria decision analysis, which is capable of addressing industry driven challenges. The decision analysis system 100 provides a practical framework of necessary steps needed to achieve a world-class security management status throughout a life-cycle.

The system and method in accordance with the preferred embodiments may incorporate several concepts applied to security management decision analysis and improvement. These concepts include providing a definition of an adaptive security management model and life-cycle using object oriented design, using combined multi-criteria Bayesian network analytical engine. The decision analysis system 100 includes group decision support for documenting, collecting, normalizing and acting on group input. The decision analysis system uses a peer to peer computing capability to support cellular autonomous or coordinated interaction across domains.

A system management decision analysis system 100 and process may be implemented for designing, optimizing and managing any system process The principles of the preferred embodiment however are not limited to IT Security management and can be applied to nearly all disciplines including service management, resource management, asset management, physical security, governmental and military security, corporate security and other areas.

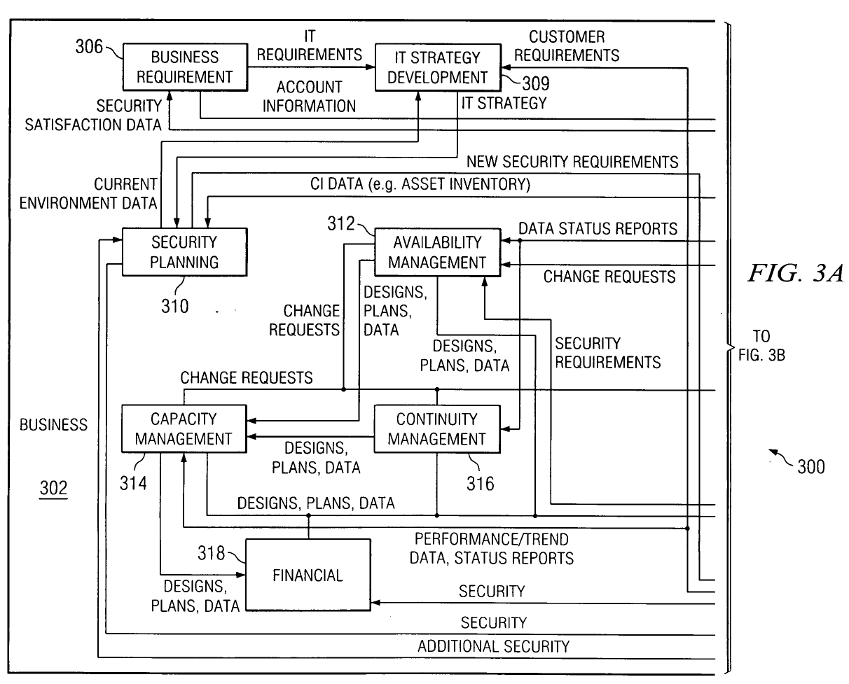

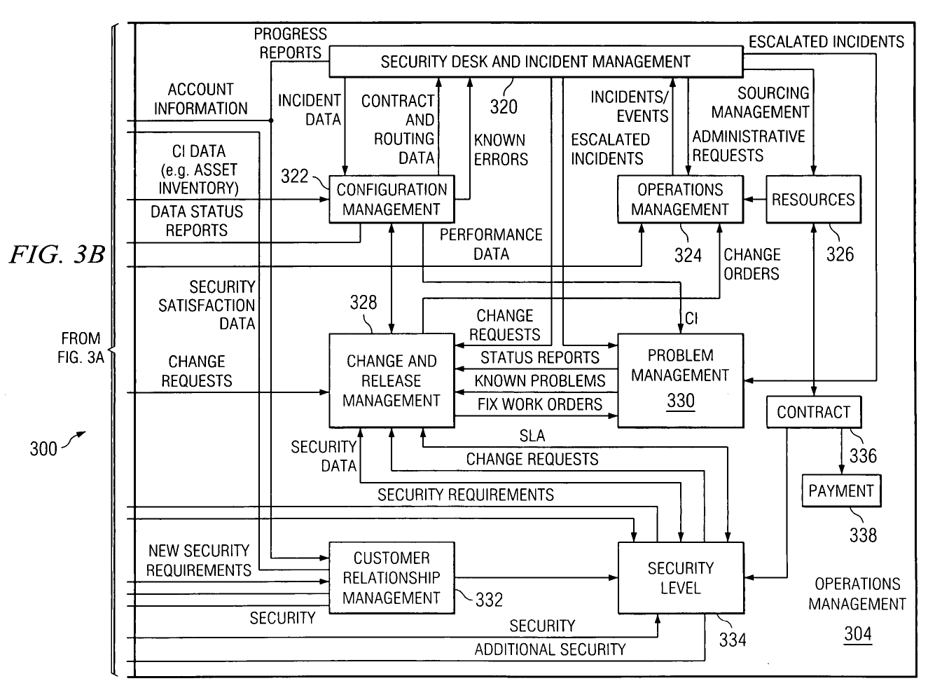

With reference to FIG. 3, a functional block diagram of a decision frame 300 is shown. A business unit 302 and operations management 304 interact in this process. Given security reports and plans, business requirements are established 306. IT requirements and customer requirements feed IT strategy development 308. With regard to security, security planning 310, availability management 312, capacity management 314 and continuity management 316 interact with financial reporting 318. Operations management 304 includes security desk and incident management 320. Sourcing management is conducted using resources 326 feeding operations management 324, configuration management, change and release management, problem management 330. The customer relationship management 332 and security level 334 may change in response to contract 336 and payment 338.

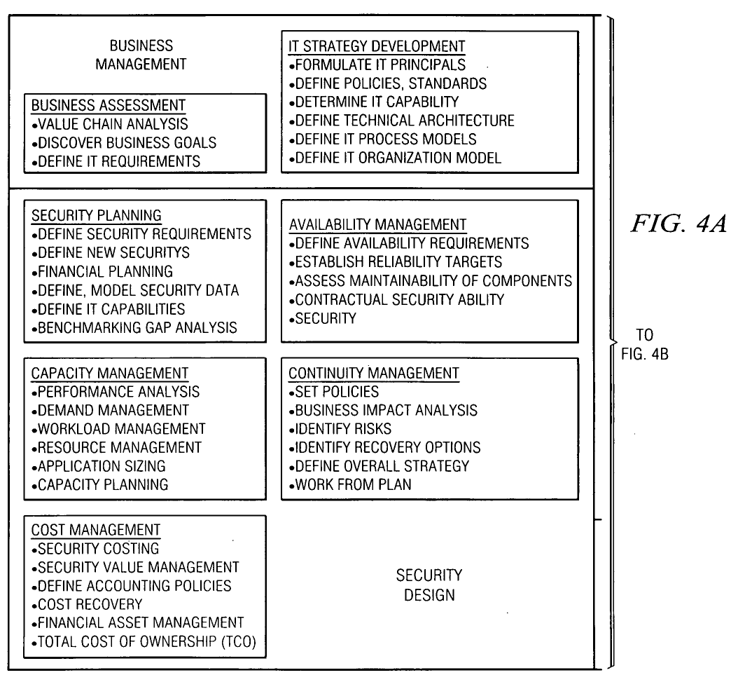

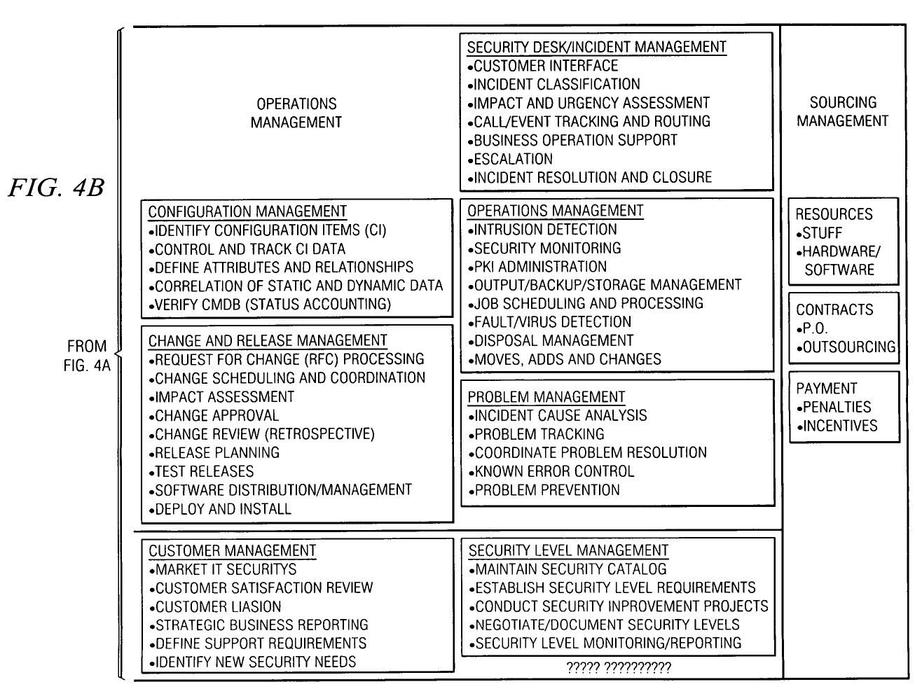

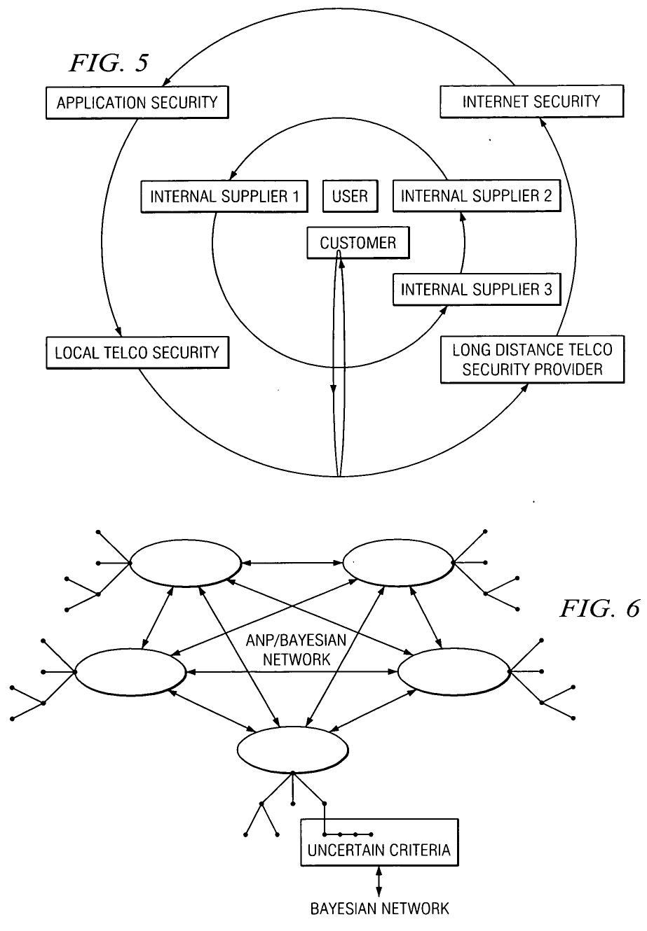

With reference to FIG. 4, an IT security process overview is shown. With reference to FIG. 5, a peer-to-peer configuration flow is shown. With reference to FIG. 6, a multi-criteria ANP/Bayesian analysis chart is shown.

The security management decision analysis system 100 includes peer-to-peer decision frames 116 that can reside in one or more components of the system, including the facilitator 102 and the decision groups 110. The peer-to-peer decision frames 116 may communicate according to rules similar to the PKI schema approach documented in the IETF RFC 2587. Each decision group 110 can be designed to function independently or as a member of one or more security hierarchies or networks.

Each decision group 110 implements a database 114 and decision frames 116 that represent various security viewpoints available in the system to the users. The database 114 and decision frame views 116 are designed to support the roles and processes required to support the life-cycle of a security service or its components. A typical security life-cycle may include; scoping, assessing, planning, requirements definition, analysis, design, development, implementation, monitoring, review, ongoing improvement and security service retirement. The security components may include; policy and process definitions and relationships, roles, organizational design, metrics, technology, support tools, reports and financial information.

The decision frames 116 may include; an overall security management frame, a security level management frame, a supplier management frame, a capacity management frame, a financial management frame, an availability management frame, a business continuity frame, a change management frame, a configuration management frame, a release management frame, a service desk frame, a problem management frame, an incident management frame, a security management frame.

The decision support frames 116 may incorporate security management frameworks such as the ISO 17799, SSE CMM Model, SEI Octave Library other security management methods. The decision support frames 116 may be implemented in object oriented models supported with XML formatting. The Interchange Format for Bayesian Networks and Microsoft's XBN format are examples of Bayesian XML data exchange specifications.

The decision frames 116 facilitate cross frame process data transfer and decisions according to the objectives specified at the root of the security hierarchy. An example of such facilitation would be the establishment of security portions of a contract between a customer and a security organization. The security agreement needs customer requirements input, assessment and feedback from the various units supporting the security organizations regarding their ability to deliver security to the level required and the establishment of new security capabilities if needed. Another example of facilitation would be for decisions shared between policy makers and policy analysts.

A frame manager 115 coordinates requests from the decision support frames 116 to the needed data 114, models 118 and network resources 138. The decision support frames 116 include a data specification format and a secure communication interface for transactional execution across system layers.

The security management decision analysis system 100 including the facilitator 102 and the decision groups 110 use a combination of multi-criteria decision analysis 120 and Bayesian Belief networks (BBN) 122 to represent a network of decision criteria. This combination of analytical techniques facilitates complex representation and adaptive combinations of empirical and or subjective and or uncertain data and related models. The decision analysis system 100 handles multi-criteria decision forward and feedback analysis, conflicting objectives, subjective judgements and uncertain data. Moreover the decision analysis system 100 facilitates a systematic and adaptable group and or individual decision making process to prioritize, recommend and monitor specific actions.

In one design the security management decision analysis system 100 uses Analytical Network Process (ANP) 130 combined with Bayesian BeliefNetworks 122. ANP 130 is especially suitable for complex decisions, where the complex decisions involve the comparison of decision elements that are difficult to quantify. ANP 130 is based on the assumption that when faced with a complex decision the natural human reaction is to cluster the decision elements according to their common characteristics. ANP 130 involves building a networked set of relationships of decision elements and then making comparisons between possible pairs as a supermatrix 106. This gives a weighting for each element within a cluster (or level of the relationships) and also a consistency ratio (useful for checking the consistency of the data). These can be linked into an overall security management model. The capability and domain dimensions of the SSE-CMM goals and base practices are excellent starting points for defining security process decision elements and lower level relationships.

The decision analysis system 100 provides a library of decision support templates and tools 118. At each node in the decision model 118, tools such as 6 sigma 124, Mean Time Between Failures (MTBF) data 126, queuing models 128 as well as systems and network management data from other systems can be used as input. Through bi-directional data flows between the system layers and the relationships within the security network tools such as Theory of Constraint (TOC), neural networks and others can be used to identify bottlenecks and optimization priorities.

Analytic Network Process (ANP) 130 incorporates dependencies and feedback. While hierarchies are concerned with the extent of a quality among the elements being compared, a network is concerned with the extent of influence of elements on some element with respect to a given quality. A network is well suited to modeling dependence relations among components. It makes it possible to represent and analyze interactions and to synthesize their mutual effects by a single logical procedure.

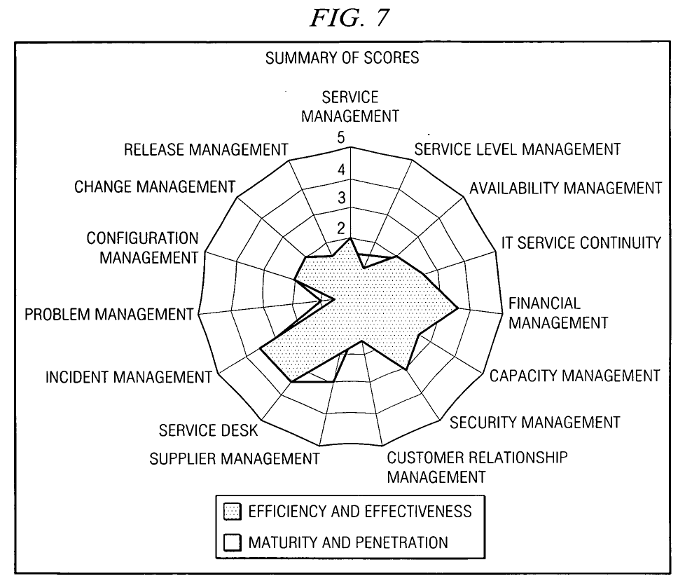

With reference to FIG. 7, a graphical representation of a process maturity model is shown. This graph may be used to identify the strengths and weaknesses of a collection of criteria, chosen for evaluation. The graph may be populated with information from the decision supermatrix.

A supermatrix 106 describing the interaction between the components of the system may be constructed from the priority vectors. It can be used to assess the results of feedback. Each of the columns in the supermatrix 106 is an eigenvector that represents the impact of all the elements in the component on each of the elements in the component. Interaction in the supermatrix 106 is measured according to several possible criteria whose priorities and relations are represented in a control hierarchy. A different supermatrix 106 of impacts is developed for each criterion. The components are compared according to their relative impact on each other component, thus developing priorities to weight the eigenvector columns in the supermatrix 106.

The ANP 130 can be structured so that it represents a Bayesian network 122. Prior probabilities are linked with the probabilities of outcomes as follows. Consider a three-level hierarchy: the goal, the current states and the outcomes. Let the column vector of prior probabilities coincide with the priorities of the current states under the goal in the hierarchy. Let the matrix of likelihoods coincide with the priorities of outcomes according to the current states. Hierarchic composition yields priorities of the outcomes that coincide with the probabilities of the outcomes as determined by conditional probability.

A feedback network, representing the dependence of causes on outcomes and the dependence of outcomes on other outcomes, is constructed by inverting the hierarchy in order to evaluate the current states in terms of outcomes. The supermatrix 106 corresponding to this network may then be generated. The mathematical machinery developed for the supermatrix 106 can then be used to derive the matrix form of Bayes Theorem.

The approach to solving decision problems being proposed has a close analogy with Goal Question Metric (GQM). The process starts by defining goals, where the goals are the objective for a decision. Next perspective is considered. An example of perspective would be considering the decision from the perspective of a security customer as opposed to the perspective of a security provider. ‘Questions’ are then asked to identifying the set of possible actions and then the set of criteria that distinguish these actions. At this point traditional GQM would define the underlying measures for your chosen criteria. Traditional Multi-Criteria Decision Analysis (MCDA) would then provide a means of combining the resulting measures for each action and provide a means of ranking the actions as a result.

The key difference is that while some criteria may be certain, and hence depend on a traditional approach to measurement, some key criteria will require uncertain inference. These criteria will depend on various factors that need to be identified. Having identified them, they are used to make predictions of the values of the uncertain criteria for the different actions. This is done using a Bayesian Belief Network (BBN) 122. Values can then be computed for each criterion for a given action and the MCDA 120 ANP 130 techniques are applied to combine the values and rank the actions.

The decision analysis system 100 combines MCDA 120 and BBN Decision 122 analysis steps by generating an agreed objective for the decision problem derived from business requirements. The decision analysis system 100 then identifies the person or role from whose perspective the problem must be solved. The decision maker and the stakeholders 134 are identified. The decision analysis system 100 identifies the set of possible actions that will form the set of alternatives available, using the assessment. The decision analysis system identifies the set of criteria, that is the attributes of actions, which are used to determine the choices available. The decision analysis system 100 identifies any fixed constraints, that is properties of criteria that must be satisfied for any chosen action. The decision analysis system further determines which criteria are uncertain. These uncertain criteria include criteria that can only be calculated for a given action using uncertain inference. The decision analysis system 100 determines the criteria can be calculated including quantitative and qualitative criteria.

For the certain criteria, the decision analysis system 100 determines appropriate definitions to enable an unambiguous mapping of actions into a totally ordered set. There is no harm if the ordered set is a simple ordinal scale as long as clear rules are defined for the mapping. If a criterion is vague or complex, it may be necessary to decompose it into lower level attributes. However, all initial definitions of the certain criteria (including any decomposition) must be done separately from the BBN 122.

For the uncertain criteria, the decision analysis system 100 identifies the factors that will affect the criteria. There will generally be external factors that cannot be controlled, such as the weather or the price of commodities and some internal ones that can be control, such as salaries and operating hours. Having identified the criteria, the decision analysis system 100 provides the construction of one or more BBNs 122 for the various factors and uncertain criteria.

The decision analysis system 100 calculates values, within some probability bounds in the case of the uncertain criteria, for each criterion for a given action. This allows the decision analysis system 100 to apply Analytical Network Process 130 techniques to combine the values for a given action and then to rank the set of actions. In the case of the uncertain criteria the decision analysis system 100, for example, may apply values for ‘most likely’ as well as the upper and lower bounds. If the result of the analysis produces a unique ‘best’ action which satisfies all of the defined constraints then a final decision recommendation is generated. If not, the decision analysis system 100 relaxes various constraints or introduce new actions before beginning the process again for an additional round of analysis.

The decision analysis system 100 may include an asynchronous peer to peer or client server to assist and perform the functions of one of the decision groups 110. Each decision group 110 may create, store categorize, and communicate and retrieve relevant information for group decision within a time constraint. The facilitator 102 may include a facilitation support system which helps the facilitator assign the experts to the group, organize decision, aggregate the data from the decision database, and monitor the progress of the process. The decision tools 118 may include an MCDA/Bayesian model base, or intelligent shell, which contains several available applications of MCDA/Bayesian techniques as well as other decision analysis techniques. The decision group 110 implements a rule-based system which guides users to select an appropriate technique (model) from the model base or decision tools 118. The next step is for the facilitator 102 to distribute the aggregated results to the experts 132. If a consensus needs to be reached, the experts 132 may respond to the aggregated results by expressing their preferences again. This round of decision continues until the problem is clearly structured. Then the facilitator 102 calls on an intelligent, rule-based component embedded in the facilitator system 102 for the selection of an appropriate model according to the structure of the problem. Once the model is selected, the second round of decision begins. The experts 132 and decision groups 110 can be the same as the one in the first round of decision, or different. The experts 132 are asked to evaluate the criteria and alternatives from their points of view. Then the facilitator 102 aggregates the individual preferences again and promotes the consensus (if necessary) through group correspondence.

The result of the process will be that the assessment data needed by the selected model are obtained. The structure of the problem can be displayed diagrammatically and attached with the experts' input documents

With the input of the available data into the selected model, the facilitator 102 evaluates the alternatives by running the model. Final decision suggestions together with some appropriate explanations are either reported to the user or the group of experts for approval. The whole process is iterative (rather than strictly sequential) until the final decision results are generated by the system. All information obtained from this process is stored in a system database and can be retrieved for future decision situations.

The decision tools 118 include an MCDA/BAYESIAN model base and a rule-based system interface. The decision tools comprise an intelligent shell which contains a library of MCDA/BAYESIAN techniques with the ability to recommend the best for a particular decision situation. The decision tools are a ‘shell’ in the same way as we talk about expert systems shells, which provide certain functionality and interface but need to be fed with some knowledge—i.e., in this context, a range of models.

All components of the system are optimally available using the integrated messaging infrastructure of a peer-based messaging and communication system such as provided by Groove®. This type of system offers a peer-to-peer or distributed client/server platform that allows applications and data to be shared by groups of users across a network. This infrastructure ensures that information is not only stored in or retrieved from the database between users and the system, but can be routed between users and even between different components of the system.

The asynchronous decision group servers are a component of the decision analysis system 100. Each decision group server 110 may access a decision database 114 which stores structured information obtained from each expert 132 of the decision group 110. The expert 132 can respond either to the facilitator's 102 requests or other group member's suggestions by entering his or her own preference for the problem, such as the definition, data hierarchy, and set of assessment criteria for the problem, the level of importance for each criteria, and so on. This data may be organized structurally in different fields by Groove Forms or other formats, so that relevant data can be retrieved afterwards.

Predefined agents embedded in the facilitation support component 102 ensure that all of the related information from the experts 132 can be captured periodically and routed to the facilitator 102 automatically for further aggregation. The decision database 114 holds all the information about the correspondence among the experts 132 with the format of main documents, response to the main documents, and response-to-response documents. Information related to the decision can thus be used for the future decision making situations.

The facilitation support component 102 assists the facilitator 104 to organize, drive and monitor the current MCDA/BAYESIAN process efficiently. Detailed information about the available experts 132 is recorded by name so that the facilitator 104 can assign any of them to participate in the decision. The facilitator 104 is also responsible for maintaining security control, providing experts 132 with various levels of access to the database 114. The facilitator server 102 shows the facilitator 104 the current stage of the process data with input data from individual experts 243 sorted by the names of participants and the date it was created. All the relevant data needed as an input to the intelligent, rule-based, component for the selection of a MCDA/BAYESIAN model can be identified afterwards either by the system. This process may be automated, enabled through dialog involving the facilitator 104.

Agents which have limited ‘intelligent’ features eliminate identical data, and the facilitator 104 aggregates other similar ideas manually. The facilitator 104 can also allocate access control using the PKI schema approach documented in the IETF RFC 2587. Access control can ensure that data is only accessible to relevant participants. If necessary, anonymity of the decision process can be also controlled by this component.

The decision tool component 118 is a back-end of the intelligent shell. Other models can also be included so that a wider variety of problems and tasks can be dealt with in the future. The decision tool component 118 is a rule-based component. The front end of the intelligent component in the system is a rule-based subsystem which may be coded in Groove. It comprises rules that assist a user, in particular the facilitator 104 to choose an appropriate MCDA/BAYESIAN model from the model base 118. The rules are triggered according to the type of tasks, the definition and structure of the problem, the number of criteria and alternatives, and so on. This sub-system gets data which is aggregated by the facilitator 104 and stored in the decision database 114 as input. A selected model can be retrieved based on both the input data and additional interaction between the facilitator 104 and the sub-system. The rules are flexible enough to be modified in case that more MCDA/BAYESIAN models are added in the future. There may be some situations when more than one rule can be applied. The explanations provided about each model should give enough information to the facilitator to make a final choice, or at least be aware of the limitations and advantages of using one model or another. Groove® has a capability for integration with databases, which guarantees the longevity and integrity of the information.

As an alternative the proposed system can be set up on two platforms: Groove and the World Wide Web, since Internet has also been becoming one of the common IT infrastructure for the organizations. Groove® allows its database to be converted to Hypertext Markup Language (HTML) that can be accessed through the Internet with Web browsers.

As discussed, the decision analysis system 100 can be applied to a variety of problems. The process as described applying to security can also be applied to service management, as well as many other fields. The decision analysis system 100 and method in accordance with the preferred embodiments incorporate several concepts applied to service management decision analysis and improvement. These key concepts include defining a service management model and life-cycle. A combined multi-criteria Bayesian network analytical engine is provided. There is group decision support for documenting, collecting, normalizing and acting on group input. A peer to peer computing capability is implemented to support autonomous interaction across domains.

A PKI scheme can be used in accordance with one embodiment to certify the identity and authenticate the identity of any user, expert, server or other aspect of the decision analysis system 100.

A service management decision analysis system and process is implemented for designing, optimizing and managing a service network. A service network, generally, represents the combination of elements that organizationally function to provide a service to customers. A typical service network includes such disparate elements as business requirements, information technology services, and System, Device, Network, User and Application problem spaces. Examples of information technology service networks include outsourcing organizations such as EDS, internet service providers, internal information technology organizations and third party maintenance and service providers such as Microsoft, Compaq, HP, IBM and others. The principles of the preferred embodiment however are not limited to IT Service management and can be applied to nearly all service industries including healthcare, retail, food and beverage, professional services among others.

The service management decision analysis system includes peer-to-peer decision frames 116 that can reside in one or more embodiments of the system. The peer-to-peer decision frames 116 negotiate for service primacy and hierarchy according to customer provider roles. Each peer can be designed to function independently or as a member of one or more service hierarchies.

Each decision group 110 implements a database 114 and decision frames 116 that represent various service viewpoints available in the system to the users. The database 114 and decision frame 116 views are designed to support the roles and processes required to support the life-cycle of a service or its components. The service life-cycle includes; scoping, assessing, planning, requirements definition, analysis, design, development, implementation, monitoring, review, ongoing improvement and service retirement. The service components include; policy and process definitions and relationships, roles, organizational design, metrics, technology, support tools, reports and financial information.

The decision frames 116 may include; an overall service management frame, a service level management frame, a supplier management frame, a capacity management frame, a financial management frame, an availability management frame, a service continuity frame, a change management frame, a configuration management frame, a release management frame, a service desk frame, a problem management frame, an incident management frame, a security management frame. The decision support frames may incorporate service management frameworks such as the IT Information Technology Library or other service management methods. The decision support frames may be implemented in XML format. The frames can then facilitate cross frame process data transfer and decisions according to the objectives specified at the root of the service hierarchy. An example of such facilitation would be the establishment of a service level agreement between a customer and an IT organization. The service level agreement needs customer requirements input, assessment and feedback from the various units within the IT organizations regarding their ability to deliver the service to the level required and the establishment of new service capabilities if needed.

Several service management criteria metrics are considered. The general approach to scoring is as follows: For each service management discipline, the decision analysis system 100 considers the questions and the corresponding answers. Using the consultant's knowledge and experience, the decision analysis system 100 synthesizes an overall impression of the state of that discipline. It is helpful to incorporate key words and phrases from this synthesis in a summary section at the end of the discipline description. The decision analysis system 100 compares this overall impression with the scoring guidelines for each dimension detailed below and select the score that most closely matches the description.

One example of this type of decision analysis tool is MPEE Scores. Scores are entered into MPEE Scores worksheet on a Base-One Scoring Template. An MPEE Scores worksheet includes: Maturity and Penetration, which is typically given a total of 5 marks and Efficiency and Effectiveness which together combine for 5 marks. This two level breakdown is published through the mechanism of the Boston Box. The two added together, give a score out of ten, which is used in the colour-coded tables. To achieve consistency in scoring, it has been found helpful to break down each of the two main components into their constituent parts: maturity, penetration, efficiency and effectiveness.

The MPEE worksheet is the information capture form, providing formatted entry of all four score elements for each of the 15 disciplines. It also allows for capture of the rationale for each score—in terms of key words or phrases. The Base-One Scoring Template uses the MPEE scores to calculate individual process totals and the final percentage. It also generates all the standard graphics that are required for inclusion in the report and presentation.

It will be appreciated by those skilled in the art having the benefit of this disclosure that this invention provides a decision analysis system and method. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A decision analysis system comprising:
a first decision group;
a model base communicably connected to the first decision group, including models representing multi-criteria decision analysis and Bayesian analysis techniques;
wherein upon receiving a decision task, the first decision group organizes the decision analysis process for the decision task by identifying decision analysis components and where said first decision group selects one or more appropriate models from the model base for each decision analysis component.

2. The decision analysis system of claim 1, wherein said first decision group includes a first user and a second user, where said first user and said second user are communicably connected via a network.

3. The decision analysis system of claim 1, further comprising a second decision group, wherein said first decision group and said second decision group are communicably connected via a network.

4. The decision analysis system of claim 2, further comprising a second decision group, wherein said first decision group and, said second decision group are communicably connected via a network.

5. The decision analysis system of claim 2, wherein said first user and said second user are communicably connected via a network in a peer-to-peer fashion.

6. The decision analysis system of claim 3, wherein said first decision group and said second decision group are communicably connected via a network in a peer-to-peer fashion.

7. The decision analysis system of claim 2, wherein said network is an open network.

8. The decision analysis system of claim 1, wherein said decision group includes a decision group server.

9. The decision analysis system of claim 1, wherein said decision group includes at least one expert.

10. The decision analysis system of claim 1, further a second decision group, such that decision analysis components are assigned by a facilitator to the first decision group based on the expertise of the first decision group.

11. The decision analysis system of claim 1, wherein said multi-criteria decision techniques include analytical network processing techniques.

12. A method of performing decision analysis comprising the steps of:
defining a decision for decision analysis;
assigning an expert to a first decision group;
organizing the decision analysis into decision components;
communicating a decision components to a first decision group;
selecting one or more models from a model base by the first decision group;
applying the selected model by the expert assigned to the first decision group;
reporting decision analysis results;
aggregating decision analysis results to generate aggregated decision analysis results;
reporting the aggregated decision analysis results to the first decision group.

13. The method of claim 11, wherein said step of defining a decision includes generating input on the decision from a decision group.

14. The method of claim 11, wherein said decision group may access network resources.

15. The method of claim 11, wherein said model base includes multi-criteria decision analysis techniques.

16. The method of claim 11, wherein said model base includes Bayesian analysis techniques.

17. The method of claim 11, further comprising a second decision group.

18. The method of claim 16, wherein said first decision group and said second decision group are communicably connected.

19. The method of claim 17, wherein said facilitator and said first decision group and said second decision group are connected via an open network.

20. The method of claim 17, wherein said first decision group and said second decision group are connected in a peer-to-peer fashion.

21. The method of claim 11, wherein said reporting of said aggregated decision analysis results becomes the starting point for a second round of decision analysis.

22. A service management decision analysis system comprising:
a service management decision group;
a model base communicably connected to the service management decision group, including models representing multi-criteria decision analysis and Bayesian analysis techniques;
wherein upon receiving a decision task, the service management decision group organizes the decision analysis process for the decision task by identifying decision analysis components and where said service management decision group selects one or more appropriate models from the model base for each decision analysis component.

23. A method of performing service management decision analysis comprising the steps of:
defining a service management decision for decision analysis;
assigning an expert to a service management decision group;
organizing the decision analysis into decision components;
communicating a decision components to a service management decision group;
selecting one or more models from a model base by the service management decision group;
applying the selected model by the expert assigned to the service management decision group;
reporting decision analysis results;
aggregating decision analysis results to generate aggregated decision analysis results;
reporting the aggregated decision analysis results to the service management decision group.
